(19) United States
(12) Patent Application Publication
(10) Pub. No.: US 2007/0014893 A1
(43) Pub. Date: Jan. 18, 2007

(54) Method of and apparatus for cheese processing

(76) Inventors: Gregory Charles Misson, Tauranga (NZ); Francis Patrick Dunlop, Palmerston (NZ)

Correspondence Address: YOUNG & THOMPSON, 745 SOUTH 23RD STREET, 2ND FLOOR, ARLINGTON, VA, 22202, US

(21) Appl. No.: 10/569,500

(22) PCT Filed: Aug. 25, 2004
(86) PCT No.: PCT/NZ04/00200

§ 371 Date: Sep. 27, 2006

(30) Foreign Application Priority Data
Aug. 28, 2003 (NZ) 527840

(51) Int. Cl. A23C 9/12

(52) U.S. Cl. 426/36

(57) ABSTRACT

An apparatus for and method of processing cheese milk and producing cheese therefrom. The apparatus includes a pair of vats each having an inlet and an outlet. The outlet of the first vat is connected to the inlet of the second vat by a conduit. The second vat is mounted lower than the first vat to enable a gravity feed therebetween. A de-waterer removes whey is provided between the two vats, where the de-waterer is controlled by a pair of valves. One valve is provided in an exhaust from the de-waterer and the other valve is provide between the de-waterer and the second vat. Both vats have stirers mounted therein. The stirer in the first vat is mounted to cut any coagulum that may form therein. The stirer in the second vat is mounted to agitate and provided substantially no cutting of any coagulum that may form therein.

### TECHNICAL FIELD

This invention relates to apparatus suitable for use in the substantially continuous or repetitive batch processing of cheese milk into cheese. Cheese is basically a milk concentrate, the casein and fat therein having been concentrated approximately 10 times. No clear definition of either cheese or the stages of processing is possible as so many variants of both exist. Herein in an endeavour to clearly describe and define our invention we use the following terminology. We list them substantially sequentially to correspond to the basic transitional stages in cheese processing. However, as aforesaid, as so many variants exist and as the concentration steps are fundamentally repeated that is not say we necessarily use these terms in a manner limited to a particular stage.

Cheese milk: milk that is suitable for the processing into cheese and which may or may not contain additives to facilitate one or more of the stages in that process.

Cheese: the final or partway fused state product of the processing of the cheese milk.

Coagulating: the processing of cheese milk either wholly or partly to enable partial draining or drawing off of whey from the resultant cheese coagulum.

Coagulum: the result from coagulation

Cutting: the process of cutting cheese coagulum into curd.

Curd: cheese coagulum in granular or other particulate form.

Syneresis: the separation of whey from cheese curd as a consequence of the combined effect of bacteria growth, mechanical and heat treatment.

Whey: residual liquid after cheese milk has been solidified either to a coagulum or the coagulum syneresised.

De-watering: the drainage or drawing of whey and/or other liquid during the process.

### BACKGROUND ART

Traditionally cheese milk is continuously or repetitively batch processed in thermally controlled vats. Mechanical means are utilised within the vats to stir the milk and as it coagulates to also cut the coagulum enabling de-watering to take place. These treatments together with the addition of bacteria culture provide the syneresis resulting in cheese. It is well known that altering any one of these can cause damage, loss of quality and/or alter the characteristics of the final cheese.

In some instances the coagulum is allowed to settle to facilitate de-watering. This can necessitate the supplementary cutting of the coagulum and/or the addition of water to enable the stirring to continue. Either of these “supplementary” steps can in some cases cause undesirable damage or waste. An object of this invention is to eliminate or substantially avoid the need for such “supplementary” steps. A further object is to provide a useful choice of apparatus and/or methods for cheese processing.

### DISCLOSURE OF INVENTION

According to a first aspect of this invention there is provided a method of substantially continuously processing cheese milk in the producing of cheese therefrom broadly comprising the steps of charging a thermally controlled vat incorporating stirring means with a quantity of cheese milk and stirring same for a required period, being a period less than necessary for substantial coagulation thereof to occur, to create a mixture that includes a quantity of whey, then transferring that mixture to a second thermally controlled vat incorporating agitator means and during the transfer stage de-watering the mixture to remove a required amount of the whey therefrom, and then within the second vat agitating the reduced whey mixture for a required period prior to forwarding that agitated reduced whey mixture on for further downstream processing, and after discharging the mixture from the first vat, preparing and re-charging the first vat with another quantity of cheese milk and repeating the aforesaid steps including after discharging the second vat preparing it to receive a further charge of reduced whey mixture.

According to a second aspect of this invention there is provided an apparatus for use in the substantially continuous processing of cheese milk in the production of cheese therefrom broadly comprising a pair of thermally controlled vats each incorporating an inlet and an outlet as well as stirring means with the outlet of a first of the vats being joined to the inlet of the second of the vats via de-watering means.

According to a third aspect of this invention there is provided an apparatus as described in the preceding paragraph wherein the stirring means within the first vat operate through a majority of the interior thereof as will tend to cut any coagulum as it develops therein while the stirring means in the second vat operates in a lower zone of the interior thereof only as will result in substantially no cutting of any coagulum that may form in the second vat.

According to a fourth aspect of this invention there is provided an apparatus as described in either of the two immediately preceding paragraphs wherein the first vat is disposed higher than the second vat as to enable a gravity feed of the contents thereof to the second vat, and de-watering means are disposed in-line in a conduit connecting the outlet of the first vat to the inlet of the second vat.

### BRIEF DESCRIPTION OF DRAWING

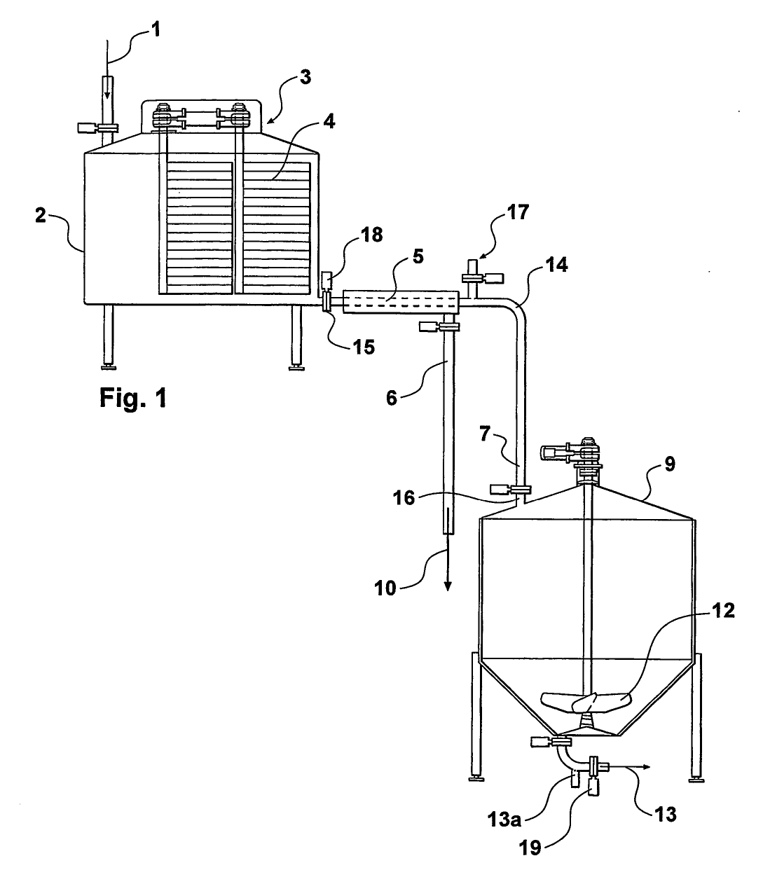

In further describing the invention reference is made to the accompanying FIG. 1 drawing being a partly schematic side elevation view of a preferred embodiment.

### BEST MODES OF CARRYING OUT THE INVENTION

A pair of vats 3 and 9 are adapted for inclusion in the processing of cheese milk into cheese. Both vats 3 and 9 are preferably thermally controlled in a known manner such as by heating jacket 11. The vats 3 and 9 are a joined by a conduit 14. Preferably the second of the vats 9 is disposed lower than the first of the vats 3 enabling a gravity feed of the contents of the first vat 3 through to the second vat 9.

Vat 3 has an input 1 for cheese milk and has stirring means, preferably in the nature of power driven rotating knives 4, therein. Preferably the knives 4 are disposed in banks one above the other to operate substantially through the complete interior of the vat 3. It is intended that the knives 4 will cut any coagulum as it develops within the vat 3. Vat 9 also has stirring means therein these preferably being in the nature of an agitator 12 mounted to operate in a lower zone only of the vat 9. Preferably the agitator 12 has broad blades disposed in a substantially vertical plane as it is intended that the agitator 12 will have substantially no cutting effect on any coagulum that may form in vat 9.

De-watering means 5 preferably in the nature of a filter are provided between the two vats 3 and 9. Preferably the de-watering means 5 are incorporated in line within the conduit 14 to filter off, such as to exhaust 10, a required amount of whey. Additionally or alternatively the de-watering means 5 may provide for direct drawing off of whey. Preferably a flow control valve 6 is provided in exhaust 10 and a back pressure valve 7 within the conduit 14 between the de-watering means 5 and the downstream vat 9 to enable control of the de-watering means 5. In addition to enable separate preparation/cleaning of the vats 3, 9 and associated equipment as described below a cleaning fluid inlet 17 and further control valves 18, 19 are provided.

In use a quantity of cheese milk can be charged into vat 3 and processed therein, including stirring and cutting, by knives 4 for a desired period. The period is terminated after a mixture of coagulant and whey begins forming with preferably the period being sufficient for substantial cutting of the developing coagulant to take place. The resultant mixture in vat 3 is then completely transferred to vat 9 via conduit 14. In so doing the mixture is de-watered through de-watering means 5 to remove a required amount of whey therefrom. The quantity of whey de-watered from the mixture can be controlled by appropriately operating the valves 6 and 7 to extract the whey via exhaust 10. The whey reduced milk and coagulum mixture is then further processed including agitation in vat 9. The first vat 3 is thus free for cleaning and recharging with a further quantity of cheese milk. Preferably this re-charging of vat 3 is undertaken immediately after the original quantity of cheese milk has been discharged therefrom, that is, during the period the agitation is taking place in the second vat 9. To that end valve 7 can be closed to isolate off vat 9 and cleaning fluid introduced via inlet 1 and or inlet 17 exhausting via exhaust 10. Similarly, the preparation of the second vat 9 is undertaken while the first vat 3 is enabled in the cheese processing, valve 18 being closed to isolate off vat 3. and cleaning fluid introduced via inlet 17 to discharge via exhaust 10 and outlet 13a.

1. A method of substantially continuously processing cheese milk in the producing of cheese therefrom comprising the steps of charging a thermally controlled vat incorporating stirring means with a quantity of cheese milk and stirring same for a required period, being a period less than necessary for substantial coagulation thereof to occur, to create a mixture that includes a quantity of whey, then transferring that mixture to a second thermally controlled vat incorporating agitator means and during the transfer stage de-watering the mixture to remove a required amount of the whey therefrom, and then within the second vat agitating the reduced whey mixture for a required period prior to forwarding that agitated reduced whey mixture on for further downstream processing, and after discharging the mixture from the first vat, preparing and re-charging the first vat with another quantity of cheese milk and repeating the aforesaid steps including after discharging the second vat preparing it to receive a further charge of reduced whey mixture.

2. A method of substantially continuously processing cheese milk in the producing of cheese therefrom as claimed in claim 1 wherein the preparation and re-charging of the first vat is undertaken during the period the reduced whey mixture is being agitated in the second vat and the second vat is prepared to receive a further charge of reduced whey mixture during the period that charge of mixture is being processed in the first vat.

3. An apparatus for use in the substantially continuous processing of cheese milk in the production of cheese therefrom broadly comprising a pair of thermally controlled vats each incorporating an inlet and an outlet as well as stirring means with the outlet of a first of the vats being joined to the inlet of the second of the vats via de-watering means.

4. An apparatus as claimed in claim 3 wherein the stirring means within the first vat operate through a majority of the interior thereof as will tend to cut any coagulum as it develops therein while the stirring means in the second vat operates in a lower zone of the interior thereof only as will result in substantially no cutting of any coagulum that may form in the second vat.

5. An apparatus as claimed in claim 3, wherein the first vat is disposed higher than the second vat as to enable a gravity feed of the contents thereof to the second vat, and de-watering means are disposed in-line in a conduit connecting the outlet of the first vat to the inlet of the second vat.

6. An apparatus as claimed in claim 3, inclusive wherein the dewatering means is controlled by a pair of valves, one valve being provided in an exhaust from the de-watering means and the second valve being provided between the dewatering means and the second vat.

7.-9. (canceled)
